(19) United States
(12) Patent Application Publication
(10) Pub. No.: US 2007/0036550 A1
(43) Pub. Date: Feb. 15, 2007

(54) Communications apparatus

(75) Inventors: Christopher David Baggs, Weston-Super-Mare (GB); Mohammed Nawaz, Chelmsford (GB)

Correspondence Address: BRACEWELL & GIULIANI LLP, P.O. BOX 61389, HOUSTON, TX, 77208-1389, US

(73) Assignee: Vetco Gray Controls Limited

(21) Appl. No.: 11/501,352

(22) Filed: Aug. 9, 2006

(30) Foreign Application Priority Data
Aug. 9, 2005 (GB) 0516321.7

(51) Int. Cl. H04B 10/02

(52) U.S. Cl. 398/134

(57) ABSTRACT

A communications device for underwater use includes an umbilical which contains a length of optical fibre for carrying communications signals. The umbilical also has an optical amplifier provided along said length for boosting the intensity of said signals, and an electrical power line for supplying power to the amplifier. Additionally, the umbilical has a connection device for splicing two cables, each cable carrying a length of optical fibre for carrying communications signals. The connection device has a housing having two ports for accepting respective cables, and an optical amplifier for boosting the intensity of said signals, the amplifier being supplied with power by an electrical power line carried by at least one of the cables.

### FIELD OF THE INVENTION

This invention relates to a communications apparatus for controlling and/or monitoring an underwater hydrocarbon well, a connection device for joining two cables and a method for enabling communication with an underwater well facility.

### BACKGROUND OF THE INVENTION

Control of offshore fluid extraction wells is typically effected from the shore via an umbilical. The umbilical typically carries hydraulic and electrical power, and communication for control and monitoring of the well. Earlier installations were relatively close to the shore and thus communication with the well complex could be achieved with conventional wires and modems. Later installations tended to be at greater distances from the shore, such as 100 Km, and benefited from the application of fibre optic methods of communication. Installations are now planned at distances in the order of 600 Km from the shore, which presents new problems for the supply of power and communications via an umbilical. Fibre optic communication is limited, using relatively cheap laser diodes to about 200 Km with current technology, although research organizations are proposing to stretch this to about 300 Km with further development of optical devices. Above this distance it is necessary and traditional to use either high power gas lasers or electronic repeaters (modems), both of which are expensive and power-hungry solutions.

The manufacture and deployment of a continuous length of some 600 Km of umbilical is accepted by subsea well operators as impractical and thus splicing of the umbilical is a necessity. The splicing techniques used are similar to those employed by transatlantic cable systems whereby the splice is effected in a torpedo-shaped pod of a specific shape and size. The reason for the confined specification of the splice pod is that the tension of a cable during its deployment from a cable-laying vessel is carefully controlled by a mechanism called the ‘cable-laying engine’ at the stern. This mechanism is designed to allow the passage of a splice pod of defined dimensions whilst still controlling the cable tension. Thus the splice pod in a subsea umbilical must be compatible with the facilities, such as the ‘cable-laying engine’, of a cable-laying vessel, since such vessels are also used to deploy subsea well umbilicals. The problem with electronic repeaters is that they are not only power-thirsty but bulky. This is compounded by the fact that it is normally necessary to employ at least eight and typically sixteen fibres, each with a repeater, to provide dual channel duplex operation and spares, for acceptable availability.

### SUMMARY OF THE INVENTION

It is an aim of the present invention to provide a communications system, which overcomes the above problems and enables long cables to be laid without the use of electronic repeaters.

The aim is achieved by employing a non-electronic repeater, such as Erbium Doped Fibre-optic Amplifiers (EDFAs) as repeaters in the fibre-optic cables in the umbilical. Investigations have shown that they are small enough to enable the necessary repeaters to be incorporated into a splice pod compatible with vessel deployment ‘cable laying engines’.

An EDFA power consumption typically comprises 1 watt for the laser diode, 5 watts max for the Peltier device and 4 watts for the control electronics, making a total requirement of only 10 watts. This is a significant power reduction over a conventional electronic modem repeater, which consumes typically between 16 and 28 watts, dependent on the environmental temperature.

The low power consumption of the EDFA allows its electric power supply to be fed down the umbilical via small, typically 16 mm², wires which are run alongside the fibre-optic bundles, replacing some of the ‘fillers’ used in the cable construction whilst avoiding compromising the main power feeds. Typically, power is fed at 500 V DC to minimize voltage drop down the umbilical and is then dropped to a voltage suitable for the EDFAs by small DC/DC converters.

The gain of the EDFA is typically 30 db, which allows communication with a 20 db margin over a 600 Km fibre optic link, with only two EDFAs located at 200 and 400 Km from the sources. This suits practical umbilical lengths of 200 metres, resulting in splice pods housing the EDFAs at these distances. Longer distances will require additional EDFAs.

This invention overcomes the problems outlined above and enables reliable fibre-optic communications for control and monitoring of subsea wells at distances in excess of 600 Km between the control centre and the well, whilst maintaining compatibility with cable-laying vessels during deployment of the umbilical.

In accordance with a first aspect of the invention there is provided a communications apparatus for controlling and/or monitoring an underwater hydrocarbon well, comprising an umbilical which contains:
(a) a length of optical fibre for carrying communications signals;
(b) an optical amplifier provided along said length for boosting the intensity of said signals; and
(c) an electrical power line for supplying power to the amplifier.
The amplifier is preferably an EDFA.

The optical amplifier may only pass signals in one direction. A second length of optical fibre may be provided within the umbilical, with a second respective optical amplifier provided along said second length, the arrangement of the first and second amplifiers being such that communications signals may be passed in one direction through the first length, and in a second, opposite direction through the second length. Alternatively, a portion of the length of optical fibre may be split to provide two parallel optical pathways along said portion. In this case, the optical amplifier may be provided in one of the pathways and a second amplifier provided in the other pathway, the arrangement of the amplifiers being such that communication signals may be passed in one direction through one pathway, and in a second, opposite direction throughway the other pathway.

Advantageously, the umbilical may include a connection device for joining sections of umbilical cable, and the amplifier being located within the connection device.

In accordance with a second aspect of the present invention, there is provided a connection device for joining first and second cables, each cable carrying a length of optical fibre for carrying communications signals, comprising:

(a) a housing having first and second ports for accepting respective ones of the cables; and

(b) an optical amplifier for boosting the intensity of said signals, the amplifier being supplied with power by an electrical power line carried by at least one of the cables.

Advantageously, the device may comprise a plurality of optical amplifiers.

Preferably, each optical amplifier is an EDFA.

The or each optical amplifier may be mounted on an inner wall of the housing.

In accordance with a third aspect of the present invention, there is provided an underwater hydrocarbon extraction facility comprising the apparatus according to the first or second aspects.

In accordance with a fourth aspect of the present invention, there is provided a method of enabling communication with an underwater well facility, comprising the steps of connecting an umbilical to the facility, the umbilical containing:
(a) a length of optical fibre for carrying communications signals;
(b) an optical amplifier provided along said length for boosting the intensity of said signals; and
(c) an electrical power line for supplying power to the amplifier.
Preferably, the amplifier is an EDFA.

The optical amplifier may only pass signals in one direction. A second length of optical fibre may be provided within the umbilical, with a second respective optical amplifier along said second length, the arrangement of the first and second amplifiers being such that communications signals may be passed in one direction through the first length, and in a second, opposite direction through the second length. Alternatively, a portion of the length of optical fibre may be split to provide two parallel optical pathways along said portion. In this case, the optical amplifier may be provided in one of the pathways and a second amplifier provided in the other pathway, the arrangement of the amplifiers being such that communication signals may be passed in one direction through one pathway, and in a second, opposite direction throughway the other pathway.

Advantageously, a connection device may be included for joining sections of umbilical cable, and locating the amplifier within the connection device.

### BRIEF DESCRIPTION OF THE DRAWINGS

The invention will now be described, by way of example, with reference to the accompanying drawings, in which:

FIG. 1 shows a schematic view of an EDFA;

FIG. 2 schematically shows an embodiment of the present invention enabling duplex operation;

FIG. 3 schematically shows an alternative embodiment enabling duplex operation;

FIG. 4 shows a part-sectional view of an inventive connection device; and

FIG. 5 shows an enlarged sectional view of the device of FIG. 4.

### DETAILED DESCRIPTION OF THE INVENTION

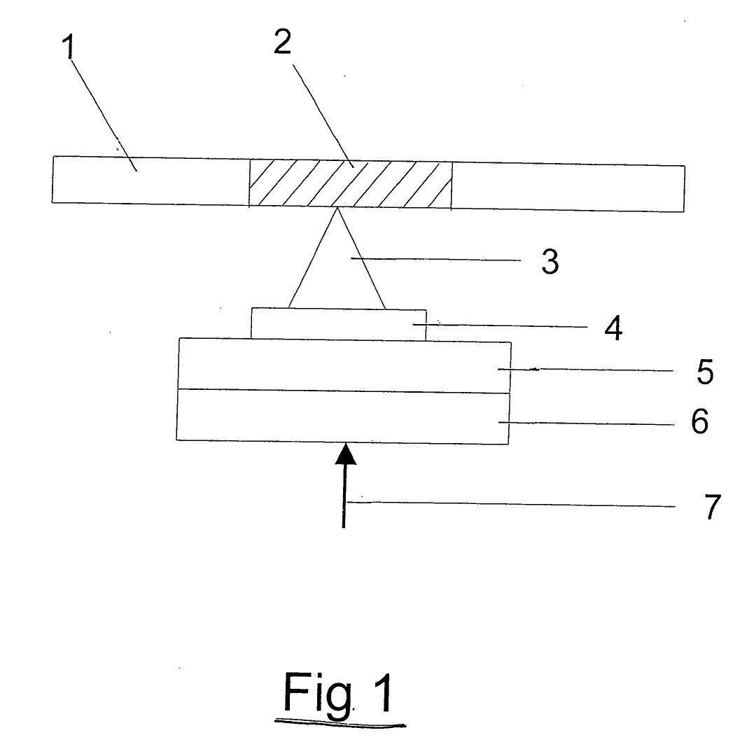

Looking firstly at FIG. 1, an EDFA is provided at a fibre-optic cable 1, which has a relatively small part of its length 2 doped with Erbium. This part is pumped by a laser diode 3 which is mounted on and cooled by a Peltier device 4. The laser diode and Peltier currents are controlled by an electronic module 5 which is supplied with electric power via a DC/DC converter 6, fed from a high voltage supply 7.

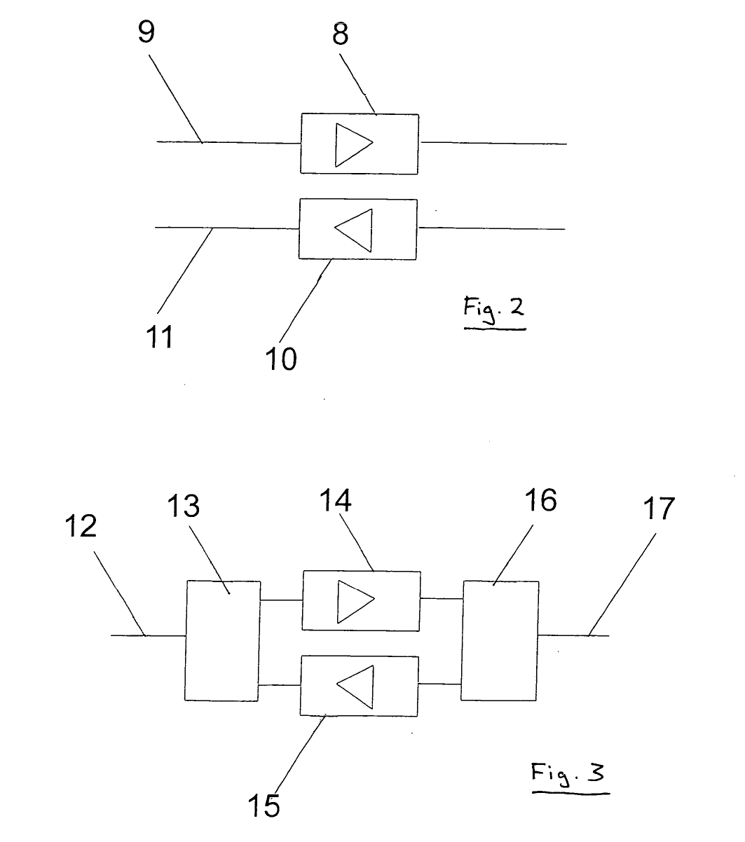

EDFAs are not full duplex devices and can only handle communication in one direction. FIG. 2 shows a first arrangement to cater for the single-way communication limitation of the EDFAs but still provide full duplex operation. An EDFA 8, inserted into a fibre-optic cable 9 provides single one-way communication left to right in the figure. A second EDFA 10 is inserted in a second fibre-optic cable 11, providing communication right to left in the figure. FIG. 3 shows an alternative arrangement, in which a fibre-optic cable 12 is split by an optical splitter 13, to feed two EDFAs 14 and 15. These EDFAs are connected to transmit in opposite directions. The output of EDFA 14 and the input of EDFA 15 are combined in a second optical splitter 16, to connect to a fibre-optic cable 17. The advantage of the FIG. 3 configuration is that full duplex operation is achieved through a single fibre-optic cable. However it has the disadvantage that there is a significant optical power loss in the optical splitters such that additional EDFAs may be necessary to cope with distances as long as 200 Km. The configuration of FIG. 2 does not have the disadvantage of optical power loss, but requires twice as many fibres to achieve full duplex operation. In practice, the choice of configuration will be determined by the actual distance that communication is required and/or the most cost effective solution to meet the requirement.

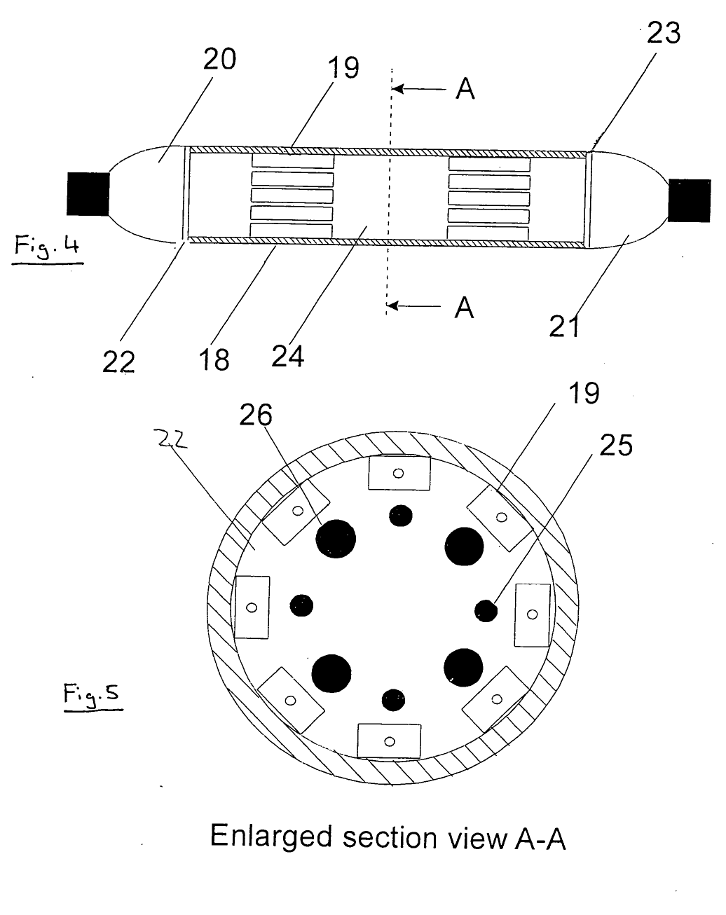

FIG. 4 shows a “torpedo-shaped” splice pod connection device 18. Located within the housing of the pod are a plurality of assemblies 19, which may for example comprise EDFAs along with their associated DC/DC convertors and optical splitters, such as shown in FIG. 3. The relatively small size of assemblies 19 allows at least sixteen of them to be housed within the pod. Typical dimensions of the pod are 3200 mm long and 622 mm in diameter. Umbilical internal elements such as power cables, hydraulic feeds, and fibre-optic cables are separated in end sections 20 and 21 of the pod 18, and pass individually through holes in section walls 22 and 23. These end sections of the pod are typically filled with resin. A centre section 24 of the pod 18 without the power cables, hydraulic feeds and fibre optic cables shown, illustrating how the EDFA assemblies 19 may be mounted on the wall of the pod, leaving adequate space for the splicing of the power cables and hydraulic feeds in the centre. This arrangement is further shown in the sectioned view A-A of FIG. 5 with power cables 25 and hydraulic feeds 26 passing through the wall 22 of the end section 20.

A key advantage of the invention is that it achieves reliable communication over the recent operator requirement of an increased distance of 600 Km between a control centre and a subsea well complex, via fibre optic cables without the use of high power gas lasers, and with a substantial reduction of power consumption. The apparatus is also suitable for incorporation into ‘standard’ torpedo-shaped field splice pods already in use in the transatlantic cable industry, thus also allowing the use of standard cable laying vessels to deploy the subsea well, power and control umbilical.

While the invention has been described with particular reference to the embodiments shown in the figures, it will be apparent to those skilled in the art that many variations are possible within the scope of the claims.

We claim:

1. An apparatus for controlling and/or monitoring an underwater hydrocarbon well, comprising an umbilical which contains:
a length of optical fibre for carrying communications signals,
an optical amplifier provided along said length for boosting the intensity of said signals, and
an electrical power line for supplying power to the amplifier.

2. The apparatus according to claim 1, wherein the amplifier is an EDFA.

3. The apparatus according to claim 1, wherein the optical amplifier may only pass signals in one direction.

4. The apparatus according to claim 3, wherein a second length of optical fibre is provided within the umbilical, with a second respective optical amplifier provided along said second length, the arrangement of the first and second amplifiers being such that communications signals may be passed in one direction through the first length, and in a second, opposite direction through the second length.

5. The apparatus according to claim 3, wherein a portion of the length of optical fibre is split to provide two parallel optical pathways along said portion.

6. The apparatus according to claim 5, wherein the optical amplifier is provided in one of the pathways and a second amplifier is provided in the other pathway, the arrangement of the amplifiers being such that communication signals may be passed in one direction through one pathway, and in a second, opposite direction throughway the other pathway.

7. The apparatus according to claim 1, wherein the umbilical includes a connection device for joining sections of umbilical cable, and the amplifier is located within the connection device.

8. An apparatus for joining first and second cables, each cable carrying a length of optical fibre for carrying communications signals, comprising:
a housing having first and second ports for accepting respective ones of the cables, and
an optical amplifier for boosting the intensity of said signals, the amplifier being supplied with power by an electrical power line carried by at least one of the cables.

9. The apparatus according to claim 8, comprising a plurality of optical amplifiers.

10. The apparatus according to claim 8, wherein the or each optical amplifier is an EDFA.

11. The apparatus according to claim 8, wherein the or each optical amplifier is mounted on an inner wall of the housing.

12. An underwater hydrocarbon extraction facility comprising the apparatus according to claim 1.

13. An underwater hydrocarbon extraction facility combining the apparatus according to claim 8.

14. A method of enabling communication with an underwater well facility, comprising the steps of connecting an umbilical to the facility, the umbilical containing:
a length of optical fibre for carrying communications signals,
an optical amplifier provided along said length for boosting the intensity of said signals, and
an electrical power line for supplying power to the amplifier.

15. The method according to claim 14, wherein the amplifier is an EDFA.

16. The method according to claim 13, wherein the optical amplifier may only pass signals in one direction.

17. The method according to claim 16, comprising the step of providing a second length of optical fibre within the umbilical, with a second respective optical amplifier along said second length, the arrangement of the first and second amplifiers being such that communications signals may be passed in one direction through the first length, and in a second, opposite direction through the second length.

18. The method according to claim 16, wherein a portion of the length of optical fibre is split to provide two parallel optical pathways along said portion.

19. The method according to claim 18, comprising the step of providing the optical amplifier in one of the pathways and a second amplifier in the other pathway, the arrangement of the amplifiers being such that communication signals may be passed in one direction through one pathway, and in a second, opposite direction throughway the other pathway.

20. The method according to claim 14, comprising the step of including a connection device for joining sections of umbilical cable, and locating the amplifier within the connection device.
